(19) United States
(12) Patent Application Publication
(10) Pub. No.: US 2026/0149293 A1
(43) Pub. Date: May 28, 2026

(54) APPARATUS AND METHOD FOR BALANCING A BATTERY CELL

(71) Applicants: HYUNDAI MOTOR COMPANY, Seoul (KR); KIA CORPORATION, Seoul (KR)

(72) Inventor: Hyun Soo Park, Hwaseong-si (KR)

(73) Assignees: HYUNDAI MOTOR COMPANY, Seoul (KR); KIA CORPORATION, Seoul (KR)

(21) Appl. No.: 19/175,533

(22) Filed: Apr. 10, 2025

(30) Foreign Application Priority Data
Nov. 22, 2024 (KR) 10-2024-0168489

(51) Int. Cl. H02J 7/00

(52) U.S. Cl. CPC H02J 7/52; H02J 7/82; H02J 7/84; H02J 7/947; H02J 7/965

(57) ABSTRACT

A battery cell balancing apparatus according to an aspect of the present disclosure includes a state of health (SOH) determination unit that determines an SOH for each battery cell of a plurality of battery cells of a battery, a state-of-charge (SOC) measurement unit that measures one or more of a voltage or a SOC for each battery cell of the plurality of battery cells, and a balancing unit that performs balancing for each battery cell of the plurality of battery cells based on one or more of a voltage or an SOC for each battery cell of the plurality of battery cells and an SOH for each battery cell of the plurality of battery cells.

### CROSS-REFERENCE TO RELATED APPLICATION

This application claims priority to Korean Patent Application No. 10-2024-0168489, filed Nov. 22, 2024, the entire disclosure of which is hereby incorporated by reference.

### TECHNICAL FIELD

The present disclosure relates to an apparatus and a method for balancing a battery cell, and more particularly, to a battery cell balancing apparatus and method which perform battery cell balancing of a high voltage battery used for eco-friendly vehicles.

### BACKGROUND

Batteries used for eco-friendly vehicles, such as electric vehicles (EV), hybrid electric vehicles (HEV), or plug-in hybrid electric vehicles (PHEV) are high voltage batteries which generate high voltages by connecting a large number of battery cells with the same specification in series/parallel.

However, even battery cells with the same specification may be unbalanced due to manufacturing deviations, changes in the performance of components (a cathode material or an anode material) due to continuous charging and discharging, deterioration of the battery cell, and the like.

The imbalance between battery cells affects the capacity, performance, and lifespan of the battery and increases the risk of fire due to overcharge or over-discharge so that battery cell balancing is required to correct imbalance between battery cells.

In the related art, the battery cell balancing is performed by measuring a voltage for each battery cell of the entire battery, consuming a charging energy of a battery cell with a higher voltage to be equal to a voltage of a battery cell with a lowest voltage or moving a charging energy of a battery cell with a higher voltage to a battery cell with a lower voltage to equalize voltages of all the battery cells.

However, the battery cell balancing according to the related art is performed without considering the state of health (SOH) of the battery cell, and therefore, a voltage deviation or an SOC (state of charge) deviation which may be normally generated according to the SOH deviation between battery cells is not considered at all. Accordingly, there is a problem in that even in a normal voltage deviation range and/or state of charge (SOC) deviation range, the unnecessary battery cell balancing is performed to consume the energy of the battery cell.

Specifically, when the battery is partially repaired, a partially failed battery module is replaced with a battery module in a new product state (100% of SOH). In this case, the SOH deviation between the existing battery module and the newly replaced battery module is significantly increased to more frequently perform unnecessary battery cell balancing, and thus, there is a problem in that the energy consumption of the battery cell is very high.

### SUMMARY

The present disclosure is created to solve the problems as described above and an object of the present disclosure is to provide a battery cell balancing apparatus and method which perform balancing on a plurality of battery modules/cells which configures a high voltage battery by considering a deterioration level of the battery module/cell.

Another object of the present disclosure is to provide a battery cell balancing apparatus and method which perform balancing on a plurality of battery modules/cells which configures a high voltage battery based on a voltage and/or SOC for each battery module/cell, an SOH for each battery module/cell, and an accumulated charge/discharge amount.

Still another object of the present disclosure is to provide a battery cell balancing apparatus and method which determine whether to perform balancing on a plurality of battery modules/cells which configures a high voltage battery by considering a voltage deviation and/or SOC deviation which may be normally generated by an SOH deviation between battery modules/cells and perform balancing.

Objects of the present disclosure are not limited to the above-mentioned object, and other objects and advantages of the present disclosure, which are not mentioned, should be understood through the following description, and should become apparent from embodiments of the present disclosure. It is also to be understood that the objects and advantages of the present disclosure may be realized by means and combinations thereof set forth in claims.

In order to achieve the above-described objects, according to an aspect of the present disclosure, a battery cell balancing apparatus includes: an SOH determination unit (e.g., calculating unit) which determines (e.g., calculates) a state of health (SOH) for each battery cell of a plurality of battery cells which configures (i.e., makes up or constituting) a battery; a state-of-charge (SOC) measurement unit which measures at least one of a voltage or a state of charge for each battery cell of the plurality of battery cells; and a balancing unit which performs balancing for each battery cell of the plurality of battery cells based on at least one of a voltage or an SOC for each battery cell and an SOH for each battery cell.

The battery cell balancing apparatus may further include an accumulated charge/discharge amount determination unit (e.g., calculating unit) which determines (e.g., calculates) an accumulated charge/discharge amount for the battery. The balancing unit may perform the balancing on the plurality of battery cells based on the at least one of the voltage or the SOC for each battery cell, the SOH for each battery cell, and the accumulated charge/discharge amount.

The balancing unit may determine whether to perform the balancing on the plurality of battery cells by considering at least one of a voltage deviation or an SOC deviation which are based on (e.g., normally generated by) an SOH deviation between the battery cells, with respect to the accumulated charge/discharge amount.

When or based on that a maximum voltage deviation between battery cells of the plurality of battery cells exceeds a sum of a predetermined threshold voltage deviation and the voltage deviation (e.g., the voltage deviation which is normally generated), the balancing unit may perform the balancing on the plurality of battery cells.

According to another aspect of the present disclosure, a battery cell balancing method includes: calculating a state of health (SOH) for each battery cell of a plurality of battery cells of a battery; measuring at least one of a voltage or a state of charge (SOC) for each battery cell of the plurality of battery cells; and performing balancing for each battery cell of the plurality of battery cells based on at least one of a voltage or an SOC for each battery cell and an SOH for each battery cell.

The battery cell balancing method may further include, prior to the performing of balancing, calculating an accumulated charge/discharge amount for the battery. The performing of balancing may include performing the balancing on the plurality of battery cells based on the at least one of the voltage or the SOC for each battery cell, the SOH for each battery cell, and the accumulated charge/discharge amount.

According to another aspect of the present disclosure, a battery cell balancing method includes: calculating a state of health (SOH) for each battery module of a plurality of battery modules which configures a battery; measuring at least one of a voltage or a state of charge (SOC) for each battery module of the plurality of battery modules. Each battery module of the plurality of battery modules includes the same number of battery cells, and performing balancing for each battery module of the plurality of battery modules based on at least one of a voltage or an SOC for each battery module and an SOH for each battery module.

The battery cell balancing method may further include, prior to the performing of balancing, calculating an accumulated charge/discharge amount for the battery. In performing the balancing, the balancing may be performed on the plurality of battery modules based on the at least one of the voltage or the SOC for each battery module, the SOH for each battery module, and the accumulated charge/discharge amount.

According to an embodiment of the present disclosure, balancing is performed on battery modules/cells which configure a high voltage battery based on a voltage and/or SOC for each battery module/cell, an SOH for each battery module/cell, and an accumulated charge/discharge amount so that an unnecessary battery cell balancing to be caused by the deterioration of the battery module/cell is prevented, thereby suppressing the energy consumption of the battery cell.

Further, according to an embodiment of the present disclosure, it is determined whether to perform balancing on battery modules/cells by considering a voltage deviation and/or SOC deviation which may be normally generated by an SOH deviation between battery modules/cells and balancing is performed so that more efficient balancing control is performed.

### BRIEF DESCRIPTION OF THE DRAWINGS

The above and other aspects, features, and advantages of the present disclosure should become apparent from the detailed description of the following aspects in conjunction with the accompanying drawings, in which:

FIG. 1 is a view for explaining a structure of a high voltage battery and a control structure of a battery management system (BMS) managing the high voltage battery;

FIG. 2 is a view for explaining a performance deviation according to an SOH deviation between battery cells;

FIG. 3 is a view for explaining an SOC deviation according to an SOH deviation between battery cells when an accumulated charge/discharge amount is 0;

FIG. 4 is a view for explaining an SOC deviation according to an SOH deviation between battery cells when an accumulated charge/discharge amount is biased toward discharging;

FIG. 5 is a diagram of a battery cell balancing apparatus according to an embodiment of the present disclosure;

FIG. 6 is a flowchart of a battery cell balancing method according to an embodiment of the present disclosure; and

FIG. 7 is a view illustrating an open circuit voltage (OCV) map according to an embodiment of the present disclosure.

### DETAILED DESCRIPTION

Hereinafter, reference is made in detail to embodiments of the present disclosure, examples of which are illustrated in the accompanying drawings and described below, and wherever possible, the same or similar elements are denoted by the same reference numerals even though they are depicted in different drawings and a redundant description thereof has thus been omitted. In the following description of embodiments, suffixes, such as “module”, and “part”, are provided or used interchangeably merely in consideration of ease in statement of the specification, and do not have meanings or functions distinguished from one another. In the following description of embodiments of the present disclosure, a detailed description of known functions and configurations incorporated herein has been omitted when it may make the subject matter of the present disclosure rather unclear. Further, the accompanying drawings are exemplarily given to describe embodiments of the present disclosure, and should not be construed as being limited to embodiments set forth herein, and it should be understood that embodiments of the present disclosure are provided only to completely disclose the disclosure and cover modifications, equivalents or alternatives which come within the scope and technical range of the disclosure.

In the following description of embodiments, terms, such as “first” and “second” and the like, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

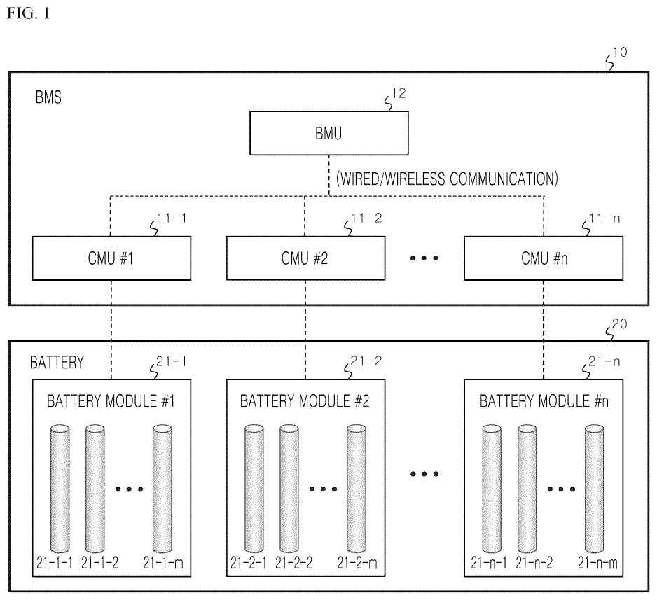

Hereinafter, a battery cell balancing apparatus and method according to embodiments of the present disclosure are described in detail with reference to FIGS. 1-7.

First, FIG. 1 is a view for explaining a structure of a general high voltage battery and a control structure of a battery management system (BMS) managing the same.

Referring to FIG. 1, the high voltage battery 20 is configured by, or comprised of, a large number of battery cells 21-1-1, 21-1-2, . . . , 21-1-m, 21-2-1, 21-2-2, . . . , 21-2-m, . . . , 21-n-1, 21-n-2, . . . , 21-n-m with the same specification to generate a high voltage. Generally, a predetermined number of battery cells 21-1-1, 21-1-2, . . . , 21-1-m, 21-2-1, 21-2-2, . . . , 21-2-m, . . . , 21-n-1, 21-n-2, . . . , 21-n-m is connected in series/parallel for the convenience for manufacturing, repair, and replacement to be manufactured as one battery module 21-1, 21-2, . . . , 21-n and the battery modules 21-1, 21-2, . . . , 21-n are connected in series/parallel again to implement a high voltage battery 20 with a desired voltage and capacity.

The BMS 10 which manages the high voltage battery 20 is configured by, or comprised of, a plurality of cell monitoring units (CMU) 11-1, 11-2, . . . , 11-n which monitors the plurality of battery modules 21-1, 21-2, . . . , 21-n and a battery management unit (BMU) 12 which manages the CMUs 11-1, 11-2, . . . , 11-n to monitor a voltage, a current, and a temperature of the battery module/cell of the high voltage battery 20 and performs the battery cell balancing to reduce the deviation between the battery modules/cells and control the high voltage battery 20 so as not to cause the overcharge, over-discharge, or overcurrent.

For reference, the battery cell balancing apparatus according to an embodiment of the present disclosure may be implemented by the BMS or by a part of the BMS, but is not necessarily limited thereto and may be implemented by a separate device from the existing BMS.

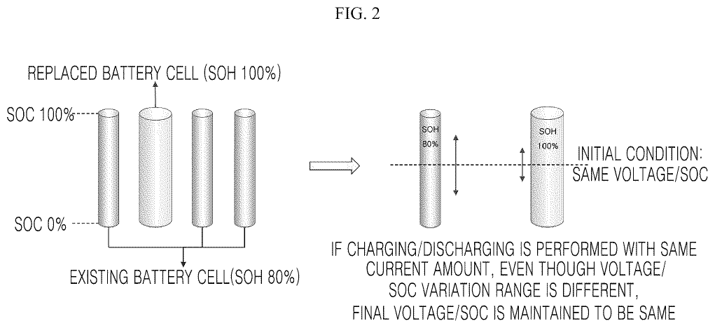

FIG. 2 is a view for explaining a performance deviation according to a state of health (SOH) deviation between the battery cells which configure a high voltage battery.

As described above, even in the battery cells with the same specification, a state of health (SOH) deviation between battery cells may be naturally generated due to manufacturing deviations, changes in the performance of components (a cathode material or an anode material) according to continuous charging and discharging, and deterioration of the battery cell. If some failed battery module is replaced with a battery module with a new product state (100% of SOH) to partially repair the battery, the SOH deviation between the existing battery module and the newly replaced battery module may be greatly increased.

In FIG. 2, it is assumed that an SOH of a battery cell included in an existing battery module which has already deteriorated is 80% and an SOH of a battery cell included in a newly replaced battery module is 100% to represent the performance difference. As illustrated in FIG. 2, even though the existing battery cell (80% of SOH) and the replaced battery cell (100% of SOH) are initially balanced with the same voltage/SOC, due to the charging capacity deviation (the existing battery cell has a smaller charging capacity than the replaced battery cell due to the deterioration) according to the SOH deviation, a variation range of the voltage/SOC of the existing battery cell is larger than a variation range of the voltage/SOC of the replaced battery cell for the charging/discharging with the same current amount. However, when the existing battery cell and the replaced battery cell are charged/discharged with the same current amount, even though the voltage/SOC variation range is different, ultimately, both the existing battery cell and the replaced battery cell return to the same voltage/SOC as immediately after the balancing.

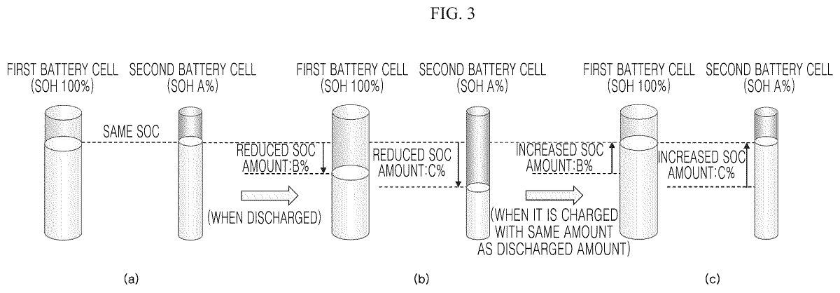

FIG. 3 is a view for explaining an SOC deviation according to an SOH deviation between battery cells when an accumulated charge/discharge amount is 0.

Referring to FIG. 3, after initially balancing the first battery cell (100% of SOH) and the second battery cell (A % of SOH) with the same SOC (see part (a) of FIG. 3), if the discharging is performed with the same quantity of charges, the SOC of the first battery cell (100% of SOH) is reduced by B % and the SOC of the second battery cell (A % of SOH) is reduced by C % (see part (b) of FIG. 3). Accordingly, there is an SOC deviation (C %-B %) between the first battery cell (100% of SOH) and the second battery cell (A % of SOH), and this is calculated by the following Equation 1, for example.

$$C - B = C - C \times \frac{A}{100} = C \times \frac{100 - A}{100} \qquad [ Equation 1 ]$$

When the first battery cell (100% of SOH) and the second battery cell (A % of SOH) are charged again with the same quantity of charges as the discharged quantity of charges, the SOC of the first battery cell (100% of SOH) is increased by B % and the second battery cell (A % of SOH) is increased by C % to be returned to the initial SOC balancing state (see part (c) of FIG. 3).

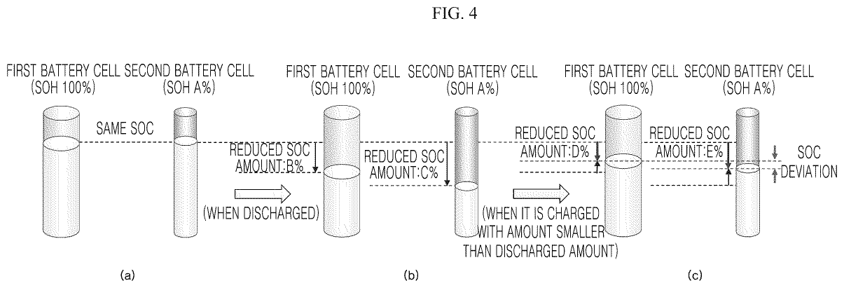

FIG. 4 is a view for explaining an SOC deviation according to an SOH deviation between battery cells when an accumulated charge/discharge amount is biased toward discharging.

Referring to FIG. 4, after initially balancing the first battery cell (100% of SOH) and the second battery cell (A % of SOH) with the same SOC (see part (a) of FIG. 4), if the discharging is performed with the same amount of charge, the SOC of the first battery cell (100% of SOH) is reduced by B % and the SOC of the second battery cell (A % of SOH) is reduced by C % (see part (b) of FIG. 4). Accordingly, there is an SOC deviation (C %-B %) between the first battery cell (100% of SOH) and the second battery cell (A % of SOH) and this is calculated by the above Equation 1, for example.

However, if the first battery cell (100% of SOH) and the second battery cell (A % of SOH) are charged with a quantity of charges smaller than a discharged quantity of charges again, they do not return to the initial SOC balancing state as illustrated in FIG. 3. Accordingly, the SOC of the first battery cell (100% of SOH) is reduced by D % and the second battery cell (A % of SOH) is reduced by E % so that the SOC deviation (E %-D %) is still generated between the first battery cell (100% of SOH) and the second battery cell (A % of SOH) (see part (c) of FIG. 4), which is calculated by the following Equation 2, for example.

$$E - D = E - E \times \frac{A}{100} = E \times \frac{100 - A}{100} \qquad [ Equation 2 ]$$

As described above, when the battery used amount after initial battery cell balancing is biased toward the charging or discharging, the SOC/voltage deviation for every battery cell is naturally generated according to the SOH deviation for every battery cell. Therefore, according to one or more embodiments of the present disclosure, the battery cell balancing is performed by considering the normal SOC/voltage deviation between battery cells to prevent unnecessary battery cell balancing and suppress the energy consumption of the battery cell.

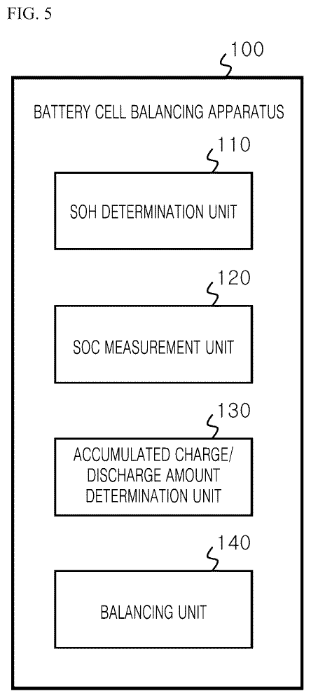

Hereinafter, a battery cell balancing apparatus and method according to an embodiment of the present disclosure is described in detail with reference to FIGS. 5-7.

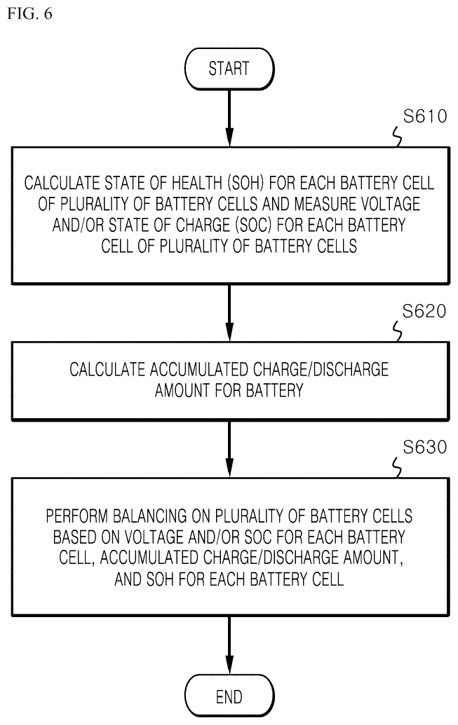

FIG. 5 is a diagram of a battery cell balancing apparatus according to an embodiment of the present disclosure and FIG. 6 is a flowchart of a battery cell balancing method according to an embodiment of the present disclosure.

Referring to FIG. 5, a battery cell balancing apparatus 100 according to an embodiment of the present disclosure includes an SOH determination unit, such as an SOH calculating unit 110, a state-of-charge measurement unit 120, an accumulated charge/discharge (i.e., charge and/or discharge) amount determination unit, such as an accumulated charge and/or discharge amount calculating unit 130, and a balancing unit 140. Hereinafter, the term charge/discharge can mean charge and/or discharge (i.e., one, both, or a combination thereof).

The SOH calculating unit 110 determines or calculates an SOH for each battery cell/each module of a plurality of battery cells which configures (i.e., that constitute) a high voltage battery (see step S610 of FIG. 6) using, for example, a known state of health (SOH) measurement method (for example, a direct measurement method, a model-based method, a data-based method, and/or an adaptive filter method).

The state-of-charge measurement unit 120 measures a voltage and/or SOC for each battery cell/each module of the plurality of battery cells that make up the high voltage battery (see step S610 of FIG. 6), using, for example, a known voltage measurement method and/or a state of charge (SOC) measurement method (for example, a voltage measurement method, an open circuit voltage (OCV) measurement method, a current integration method, a chemical measurement method, and/or a pressure measurement method).

The accumulated charge/discharge amount calculating unit 130 determines or calculates an accumulated charge amount, an accumulated discharge amount, and an accumulated charge/discharge amount for charging and discharging by measuring a charged current amount (quantity of charges) and a discharged current amount (quantity of charges) of the high voltage battery (see step S620 of FIG. 6) using, for example, a known current (charge) measurement method.

The balancing unit 140 performs balancing on the plurality of battery cells/modules based on an SOH for each battery cell/module calculated in the SOH calculating unit 110, a voltage and/or SOC for each battery cell/module measured by the state-of-charge measurement unit 120, and an accumulated charge/discharge amount calculated by the accumulated charge/discharge amount calculating unit 130 (see step S630 of FIG. 6).

As described in greater detail below, the balancing unit 140 performs the balancing to allow all the battery cells/modules which configure the high voltage battery to have the same voltage and/or SOC, regardless of the SOH of the battery cell/module at least once in an initial stage. Hereinafter, this is referred to as “hard balancing”.

When the hard balancing is performed, the accumulated charge/discharge amount calculating unit 130 resets the currently accumulated charge/discharge amount to 0.

Thereafter, the charging/discharging of the high voltage battery is performed, the accumulated charge/discharge amount calculating unit 130 measures a charge current amount (quantity of charges) and a discharge current amount (quantity of charges) of the high voltage battery to calculate the accumulated charge/discharge amount and stores it in the memory.

The balancing unit 140 determines whether to balance the plurality of battery cells/modules by considering a voltage deviation and/or an SOC deviation which is normally generated by the SOH deviation between the battery cells/modules based on the accumulated charge/discharge amount.

For example, when the maximum voltage deviation between the plurality of battery cells/modules exceeds a sum of voltage deviations which may be normally generated by a predetermined threshold voltage deviation and an SOH deviation between the battery cells/modules, the balancing unit 140 performs the balancing on the plurality of battery cells/modules. The maximum voltage deviation between the plurality of battery cells/modules may refer to the highest voltage deviation among the voltage deviations each for each battery cell/module of the plurality of battery cells/modules. Alternatively, when the maximum SOC deviation between the plurality of battery cells/modules exceeds a sum of SOC deviations which may be normally generated by a predetermined threshold SOC deviation and an SOH deviation between the battery cells/modules, the balancing unit 140 performs the balancing on the plurality of battery cells/modules. The maximum SOH deviation between the plurality of battery cells/modules may refer to the highest SOH deviation among the SOH deviations each for each battery cell/module of the plurality of battery cells/modules. Hereinafter, it is referred to as “soft balancing” to be distinguished from the above-described “hard balancing”.

The predetermined threshold voltage/SOC deviation is used to determine whether to perform the hard balancing. For example, when the SOH deviation between the battery cells/modules is not considered, if the maximum voltage/SOC deviation between the plurality of battery cells/modules exceeds a predetermined threshold voltage/SOC deviation, the hard balancing is performed. The maximum SOC deviation between the plurality of battery cells/modules may refer to the highest SOC deviation among the SOC deviations each for each battery cell/module of the plurality of battery cells/modules.

However, the balancing unit 140 according to an embodiment of the present disclosure determines whether to perform the soft balancing by additionally considering the threshold voltage/SOC deviation to determine whether to perform the hard balancing and a voltage/SOC deviation which is normally generated by the SOH deviation between the battery cells/modules. Accordingly, even though the maximum voltage/SOC deviation between the battery cells/modules simply exceeds a threshold voltage/SOC deviation, the battery cell balancing is not performed so that the unnecessary battery cell balancing is blocked.

When the soft balancing is performed, the balancing unit 140 performs the balancing on the plurality of battery cells/modules by means of passive cell balancing and active cell balancing so as to reach a target voltage/SOC (i.e., normal voltage/SOC) for each battery cell/module set based on the SOH for each battery cell/module based on the accumulated charge/discharge amount.

The voltage deviation and/or SOC deviation which is normally generated by the SOH deviation between battery cells/modules based on the accumulated charge/discharge amount may be set, for example, by each manufacturing company by means of experiments (i.e., experimenting). Similarly, the target voltage and/or target SOC for each battery cell/module set based on the SOH for each battery cell/module based on the accumulated charge/discharge amount may also be set, for example, by each manufacturing company by means of experiments.

According to an embodiment of the present disclosure, when the accumulated charge amount and/or the accumulated discharge amount exceeds a predetermined threshold accumulated amount, the balancing unit 140 performs the hard balancing based on the voltage and/or SOC for each battery cell/module, regardless of the SOH of the battery cell/module. For example, when the accumulated charge amount and/or accumulated discharge amount exceeds a predetermined threshold accumulated amount and a maximum voltage/SOC deviation between the plurality of battery cells/modules exceeds a predetermined threshold voltage/SOC deviation, the balancing unit 140 performs the hard balancing. This takes into account an error of the current sensor because when an accumulated battery used amount exceeds a predetermined level, the accumulated error of the current sensor is greatly increased.

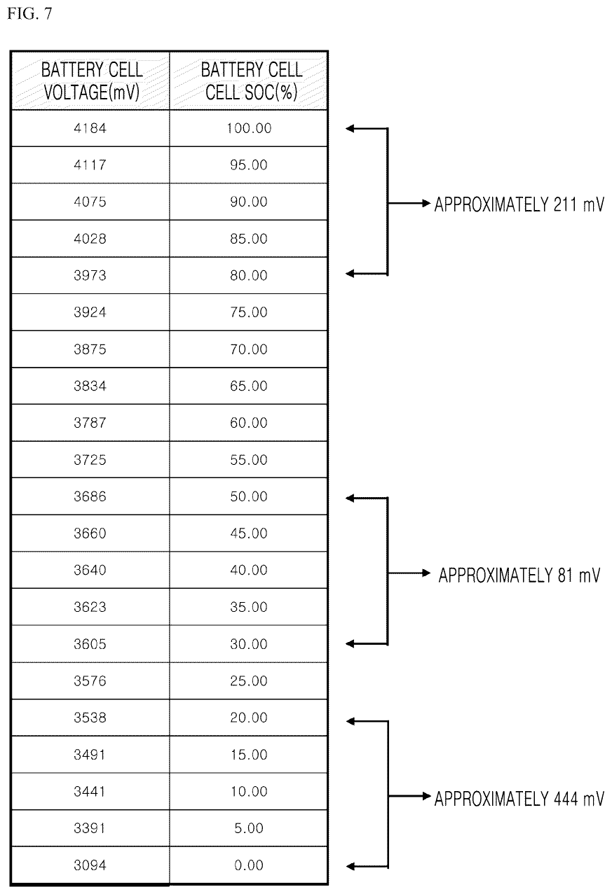

Finally, FIG. 7 is a view illustrating an open circuit voltage (OCV) map according to an embodiment of the present disclosure.

Referring to FIG. 7, the voltage and SOC of a battery cell/module may be mutually converted using an OCV map obtained through experiments by the manufacturing company so that the state-of-charge measurement unit 120 may know the remaining SOC or voltages by measuring only one of a voltage or an SOC of the battery cell/module.

However, as illustrated in FIG. 7, even though the SOC deviation is the same, a voltage deviation in every section is not the same (in FIG. 7, a voltage deviation in every section is different with the same SOC deviation of 20%) so that it is necessary to consider which SOC/voltage range the battery cell/module is in, and therefore the voltage/SOC deviation according to the SOH for each battery cell/module needs to be converted based on a reference voltage/SOC for each battery cell/module balanced by hard balancing.

In the specification (particularly, in the claims) of the present disclosure, use of the term “above” and similar referential terms may refer to both the singular and the plural. In addition, when a range is stated in the present disclosure, the statement includes an embodiment to which individual values within the range are applied (unless there is a statement to the contrary), and is the same as a statement of the individual values constituting the range in the detailed description.

Unless there is a statement of an explicit order or a statement to the contrary regarding steps constituting the method according to an embodiment of the present disclosure, the steps may be performed in any appropriate order. The present disclosure is not necessarily limited by the described order of the steps. Use of any examples or illustrative terms (for example, and the like) in the present disclosure is merely to describe the present disclosure in detail, and unless limited by the claims, the scope of the present disclosure is not limited by the examples or illustrative terms. Further, those having ordinary skill in the art should appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

1. A battery cell balancing apparatus, comprising:
a state of health (SOH) determination unit configured to determine an SOH for each battery cell of a plurality of battery cells of a battery;
a state-of-charge (SOC) measurement unit configured to measure one or more of a voltage or an SOC for each battery cell of the plurality of battery cells; and
a balancing unit configured to perform balancing for each battery cell of the plurality of battery cells based on the one or more of the voltage or the SOC for each battery cell of the plurality of battery cells and the SOH for each battery cell of the plurality of battery cells.

2. The battery cell balancing apparatus according to claim 1, further comprising:
an accumulated charge and/or discharge amount determination unit configured to determine an accumulated charge and/or discharge amount for the battery,
wherein the balancing unit is configured to perform the balancing on the plurality of battery cells based on the one or more of the voltage or the SOC for each battery cell of the plurality of battery cells, the SOH for each battery cell of the plurality of battery cells, and the accumulated charge and/or discharge amount.

3. The battery cell balancing apparatus according to claim 2, wherein the balancing unit is further configured to determine whether to perform the balancing on the plurality of battery cells by considering one or more of a voltage deviation or an SOC deviation which are based on an SOH deviation between battery cells of the plurality of battery cells, with respect to the accumulated charge and/or discharge amount.

4. The battery cell balancing apparatus according to claim 3, wherein based on a maximum voltage deviation between battery cells of the plurality of battery cells exceeding a sum of a predetermined threshold voltage deviation and the voltage deviation, the balancing unit is configured to perform the balancing on the plurality of battery cells.

5. The battery cell balancing apparatus according to claim 2, wherein the balancing unit is configured to perform the balancing on the plurality of battery cells to reach a target voltage for sets of battery cells of the plurality of battery cells based on the SOH for each battery cell of the plurality of battery cells with respect to the accumulated charge and/or discharge amount.

6. The battery cell balancing apparatus according to claim 2, wherein based on at least one of an accumulated charge amount or an accumulated discharge amount calculated by the accumulated charge and/or discharge amount determination unit exceeding a predetermined threshold accumulated amount, the balancing unit is configured to perform the balancing on the plurality of battery cells based on the one or more of the voltage or the SOC for each battery cell of the plurality of battery cells.

7. The battery cell balancing apparatus according to claim 2, wherein the balancing unit is configured to perform the balancing on the plurality of battery cells to allow the plurality of battery cells to have a same value for one or more of a voltage or an SOC, regardless of the SOH for each battery cell of the plurality of battery cells.

8. The battery cell balancing apparatus according to claim 7, wherein based on the balancing unit performing the balancing on the plurality of battery cells, regardless of the SOH for each battery cell of the plurality of battery cells, the accumulated charge and/or discharge amount determination unit is configured to reset the accumulated charge and/or discharge amount to 0.

9. The battery cell balancing apparatus according to claim 1, wherein the voltage and the SOC for each battery cell of the plurality of battery cells are mutually converted using an open circuit voltage (OCV) map.

10. The battery cell balancing apparatus according to claim 1, wherein the battery includes a plurality of battery modules comprised of a same number of battery cells,
wherein the SOH determination unit is further configured to determine an SOH for each battery module of the plurality of battery modules,
the SOC measurement unit is further configured to measure one or more of a voltage or an SOC for each battery module of the plurality of battery modules, and
the balancing unit is further configured to perform the balancing on the plurality of battery modules based on the one or more of the voltage or the SOC for each battery module of the plurality of battery modules and the SOH for each battery module of the plurality of battery modules.

11. The battery cell balancing apparatus according to claim 10, wherein the SOH determination unit is further configured to communicate with a plurality of cell monitoring units (CMU) configured to monitor each of the plurality of battery modules to determine whether to replace each battery module of the plurality of battery modules and re-determine the SOH of a battery module that is determined to be replaced.

12. A battery cell balancing method, comprising:
determining a state of health (SOH) for each battery cell of a plurality of battery cells of a battery;
measuring one or more of a voltage or a state of charge (SOC) for each battery cell of the plurality of battery cells; and
performing balancing for each battery cell of the plurality of battery cells based on the one or more of the voltage and the SOC for each battery cell of the plurality of battery cells or the SOH for each battery cell of the plurality of battery cells.

13. The battery cell balancing method according to claim 12, further comprising, prior to performing the balancing:
calculating an accumulated charge and/or discharge amount for the battery,
wherein performing the balancing includes:
performing the balancing on the plurality of battery cells based on the one or more of the voltage or the SOC for each battery cell of the plurality of battery cells, the SOH for each battery cell of the plurality of battery cells, and the accumulated charge and/or discharge amount.

14. The battery cell balancing method according to claim 13, further comprising, prior to the performing of balancing:
determining whether to perform the balancing on the plurality of battery cells by considering one or more of a voltage deviation and an SOC deviation which are based on an SOH deviation between battery cells of the plurality of battery cells, based on the accumulated charge and/or discharge amount.

15. The battery cell balancing method according to claim 14, wherein in performing the balancing, based on a maximum voltage deviation between battery cells of the plurality of battery cells exceeding a sum of a predetermined threshold voltage deviation and the voltage deviation, the balancing is performed on the plurality of battery cells.

16. The battery cell balancing method according to claim 13, wherein in performing the balancing, the balancing is performed on the plurality of battery cells to reach a target voltage for sets of battery cells based on the SOH for each battery cell of the plurality of battery cells with respect to the accumulated charge and/or discharge amount.

17. The battery cell balancing method according to claim 13, wherein in performing the balancing, based on one or more of an accumulated charge amount or an accumulated discharge amount exceeding a predetermined threshold accumulated amount, the balancing is performed on the plurality of battery cells based on the one or more of the voltage or the SOC for each battery cell of the plurality of battery cells.

18. The battery cell balancing method according to claim 12, wherein the voltage and the SOC for each battery cell of the plurality of battery cells are mutually converted using an open circuit voltage (OCV) map.

19. A battery cell balancing method, comprising:
determining a state of health (SOH) for each battery module of a plurality of battery modules of a battery;
measuring one or more of a voltage or a state of charge (SOC) for each battery module of the plurality of battery modules, wherein each battery module of the plurality of battery modules includes a same number of battery cells; and
performing balancing for each battery module of the plurality of battery modules based on the one or more of the voltage or the SOC for each battery module of the plurality of battery modules and the SOH for each battery module of the plurality of battery modules.

20. The battery cell balancing method according to claim 19, further comprising, prior to the performing of balancing:
calculating an accumulated charge and/or discharge amount for the battery,
wherein in performing the balancing, the balancing is performed on the plurality of battery modules based on the one or more of the voltage or the SOC for each battery module of the plurality of battery modules, the SOH for each battery module of the plurality of battery modules, and the accumulated charge and/or discharge amount.
